(19) United States
(12) Patent Application Publication
(10) Pub. No.: US 2017/0061285 A1
(43) Pub. Date: Mar. 2, 2017

(54) DATA ANALYSIS SYSTEM, DATA ANALYSIS METHOD, PROGRAM, AND STORAGE MEDIUM

(71) Applicant: UBIC, Inc., Tokyo (JP)

(72) Inventor: Yuki Hikone, Tokyo (JP)

(21) Appl. No.: 15/208,301

(22) Filed: Jul. 12, 2016

Related U.S. Application Data
(60) Provisional application No. 62/211,039, filed on Aug. 28, 2015.

(30) Foreign Application Priority Data
Sep. 17, 2015 (JP) 2015-184442

(51) Int. Cl. G06N 5/02; G06N 99/00

(52) U.S. Cl. CPC G06N 5/02; G06N 99/005

(57) ABSTRACT

[Object] A data analysis system designed to be capable of checking the growth process of artificial intelligence is provided. [Solution] The data analysis system includes artificial intelligence implemented by execution of a control program by a controller wherein the artificial intelligence evaluates data and classifies the data on the basis of an evaluation result, while growing through a learning step; the artificial intelligence evaluates a plurality of pieces of evaluation data; and the controller finds distribution of the evaluation of the plurality of pieces of evaluation data at a plurality of time points, further creates report information based on the distribution, and outputs the report information.

### TECHNICAL FIELD

The present application relates to a data analysis system and application of artificial intelligence suited for use in, for example, classification of information desired by users from big data.

### BACKGROUND ART

As a result of advancements in computerization in the society as caused by rapid development of computers, an enormous amount of information (big data) has become closely involved in corporate and individual activities in a wide range. Therefore, recently great importance has been attached particularly to the necessity to precisely classify desired information from among the big data.

A system that applies classification of data by a reviewer(s) to sampled data and has artificial intelligence learn the results of this classification and take the place of the reviewer to proceed with automatic classification of evaluation data is known as an approach to classify desired data from the big data (for example, Japanese Patent Application Laid-Open (Kokai) Publication No. 2013-182338).

### CITATION LIST

### Patent Literature

[Patent Literature 1] Japanese Patent Application Laid-Open (Kokai) Publication No. 2013-182338

### SUMMARY OF INVENTION

### Problems to be Solved by the Invention

According to the conventional data analysis system, the artificial intelligence grows by learning characteristics of the classification by the reviewer; and, therefore, data classification accuracy by the artificial intelligence gradually enhances and it becomes possible to obtain the desired data appropriately and promptly from the large amount of data.

However, since there was no means for users to check the growth process of the artificial intelligence, the users could not know, for example, to what degree data analysis by the artificial intelligence was functioning, and how long it would take for the data analysis system to become active for practical use after the start of the system' operation.

So, the present application was made in light of the above-described problem and it is an object of the present application to provide a data analysis system that enables the growth process of the artificial intelligence to be checked.

### Means for Solving the Problems

A first disclosure to achieve the above-described object is a data analysis system including artificial intelligence implemented by execution of a control program by a controller, the artificial intelligence evaluating data and classifying the data on the basis of an evaluation result while growing through a learning step, wherein the artificial intelligence evaluates a plurality of pieces of evaluation data; and wherein the controller: finds distribution of the evaluation of the plurality of pieces of evaluation data at a plurality of time points; and further creates report information based on the distribution and outputs the report information.

A second disclosure to achieve the above-described object is a data analysis control method for making artificial intelligence, which is implemented by execution of a control program by a computer, grow though a learning step and evaluating data by utilizing the artificial intelligence, wherein the data analysis control method includes: evaluating a plurality of pieces of evaluation data; finding distribution of the evaluation of the plurality of pieces of evaluation data at a plurality of time points; and further creating report information based on the distribution and outputting the report information.

A third disclosure to achieve the above-described object is a program for having a computer implement: a function that activates artificial intelligence; a function that makes the artificial intelligence grow through a learning step; a function that has the artificial intelligence evaluate data and classify the data on the basis of an evaluation result; a function that has the artificial intelligence evaluate a plurality of pieces of evaluation data; a function that finds distribution of the evaluation of the plurality of pieces of evaluation data at a plurality of time points; and a function that creates report information based on the distribution and outputs the report information.

A fourth disclosure to achieve the above-described object is a computer-readable storage medium with the above-described program recorded therein.

### Advantageous Effects of Invention

The above-described disclosures can realize data analysis that enables checking of the growth process of the artificial intelligence.

### BRIEF DESCRIPTION OF DRAWINGS

FIG. 1 a block diagram illustrating an example of a hardware configuration of a data analysis system;

FIG. 2 is a functional block diagram illustrating an example of a predictive coding function that the above-described data analysis system has;

FIG. 3 is a flowchart illustrating an example of processing executed by a predictive coding unit included in the above-described data analysis system;

FIG. 4 is a flowchart illustrating the operation of a program for visualizing the growth process of the artificial intelligence;

FIG. 5 is an example of a management table for control processing for visualizing the growth process of the artificial intelligence;

FIG. 6 is a graph illustrating an example of visualization information of the growth process of the artificial intelligence and a typical example of data score distribution in an initial stage of the operation of the data analysis system;

FIG. 7 is a graph illustrating data score distribution as the above-mentioned visualization information relating to an actual example when the data analysis system is still in early days of operation after it is started;

FIG. 8 is a graph relating to a typical example of data score distribution during a growth period of the artificial intelligence;

FIG. 9 is a graph illustrating data score distribution as the aforementioned visualization information in an actual example in which the operation has advanced from the system operation stage illustrated in FIG. 7;

FIG. 10 is a graph relating to a typical example of the data score distribution in a state where the growth of the artificial intelligence is in a mature period;

FIG. 11 is a graph illustrating the data score distribution as the visualization information in an actual example where the operation of the system has further advanced from the stage illustrated in FIG. 9;

FIG. 12 is graphs illustrating the relation between data and divergence for each growth stage of the artificial intelligence;

FIG. 13 is graphs illustrating the relation between data and a moving distance for each growth stage of the artificial intelligence;

FIG. 14 is a graph for explaining a tendency of the difference between an average value of scores of a “Related” data group and an average value of scores of a “Non-Related” data group to change according to the progress of the operation of the data analysis system; and

FIG. 15 is an example of a management screen for visualizing the growth process of the artificial intelligence.

### MODE FOR CARRYING OUT THE INVENTION

As one unlimited aspect of a data analysis system, there is a system for monitoring e-mails sent and received by an organization such as a company to see if the e-mails are related to or involved in illicit acts such as information leakage or cartels. The data analysis including monitoring of the e-mails is achieved by artificial intelligence operating in the data analysis system. The artificial intelligence is a virtual subject that is capable of making autonomous decisions in order to take the place of a human and assume the data analysis by the human by using control resources and storage resources such as control programs of computers.

When the artificial intelligence is given a classification result of data by a reviewer upon starting operation of the data analysis, the artificial intelligence learns characteristics of the data classification. The artificial intelligence classifies the data which is an analysis object into, for example, “Related” or “Non-Related” according to the learned characteristics. Even after the artificial intelligence starts the operation, the reviewer can actually review part of the data at specified intervals and continuously give the classification result to the artificial intelligence, so that the artificial intelligence can further learn the characteristics of the data analysis every time it receives the classification result; and the artificial intelligence can grow until a level of accuracy of the data analysis becomes equivalent to that of data analysis by an expert (such as a lawyer). As a result, the artificial intelligence can take the place of the reviewer and promptly and precisely classify object data from among a large amount of data which cannot be checked entirely by the reviewer. The details of the data analysis system will be explained below; however, an aspect of the data analysis system is not limited to what is explained below.

### Configuration of Data Analysis System

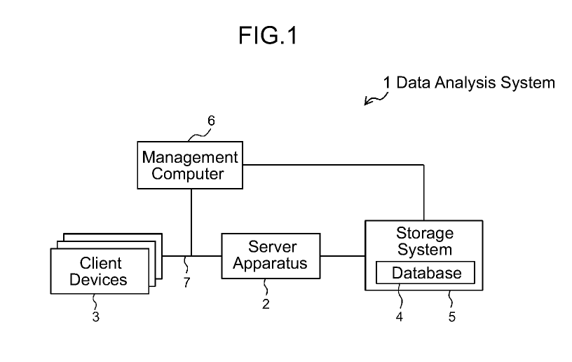

FIG. 1 is a block diagram illustrating an example of a hardware configuration of a data analysis system according to this embodiment (hereinafter sometimes simply referred to as the “system”). The system includes, for example, arbitrary storage media (such as memories and hard disks) capable of storing data (including digital data and analogue data), and a controller (such as a CPU [Central Processing Unit]) capable of executing a control program stored in the storage media, and can be implemented as a system equipped with a computer for analyzing data which is at least temporarily stored in the storage media (for example, a personal computer, a server apparatus, a client device, a workstation, or a mainframe) or a computer system (for example, a system for implementing data analysis by operating a plurality of computers, such as a server apparatus for executing main processing for the data analysis, a client device to be used by a user, and a file server storing data which is an analysis object, in an integrated manner). This embodiment mainly explains an example in which the above-described system is implemented by the latter configuration (FIG. 1).

Incidentally, in this embodiment, “data” may be any data expressed in a format that can be processed by the above-described computer. The above-described data may be, for example, unstructured data, at least part of which has incomplete structural definitions, and widely include document data at least partly including texts written in a natural language(s) (for example, e-mails [including attached files and header information], technical documents [widely including documents which explain technical matters such as academic papers, patent publications, product specifications, and designs], presentation materials, spreadsheet documents, financial statements, meeting materials, reports, sales materials, contracts, organization charts, business plans, company analysis information, electronic medical records, web pages, blogs, and comments posted on social network services), voice data (such as data in which conversations and music are recorded), image data (such as data composed of a plurality of picture elements or vector information), and video data (such as data composed of a plurality of frame images).

Moreover, in this embodiment, “learning data” (training data) may be data with which classification information is associated by a reviewer (an expert such as a lawyer or a legal staff member within a company) (classified data which is a combination of the data and the classification information). On the other hand, “evaluation data” (evaluation data) may be data with which the classification information is not associated (unclassified data which is not presented as the learning data to the reviewer). Under this circumstance, the above-described “classification information” may be identification labels used to classify the data and may be, for example, information for classifying the learning data into three groups, such as a “Related” label indicating that the data is related to a specified event, a “High” label indicating that both of them are particularly related to each other, and a “Non-Related” label indicating that both of them are not related to each other, or information for classifying the learning data into five groups, “Good,” “Slightly Good,”

“Average,” “Slightly Bad,” and “Bad.”

Furthermore, the above-described “specified event” widely includes objects whose relation with the data is evaluated by the above-described system and whose range is not limited. For example, when the system is implemented as a discovery support system, the specified case may be the relevant lawsuit for which discovery procedures are required; when the system is implemented as a criminal investigation support system, the specified case may be a criminal case which may be an object to be investigated; when the system is implemented as an e-mail monitoring system, the specified case may be an illicit act (such as information leakage or bid-rigging); when the system is implemented as a medical application system (such as a pharmacovigilance support system, a clinical trial efficiency improvement system, a medical risk hedge system, a fall-prediction [fall-prevention] system, a prognosis prediction system, or a diagnostic support system), the specified case may be a case or event related to medicines; when the system is implemented as an Internet application system (such as a SmartMail system, an information aggregation [curation] system, a user monitoring system, or a social media management system), the specified case may be a case or event related to the Internet; when the system is implemented as a project evaluation system, the specified case may be a project that was carried out in the past; when the system is implemented as a marketing support system, the specified case may be a product or service which is a marketing object; when the system is implemented as an intellectual property evaluation system, the specified case may be an intellectual property which is an evaluation object; when the system is implemented as an unfair trade monitoring system, the specified case may be a fraudulent financial transaction; when the system is implemented as a call center escalation system, the specified case may be a case handled in the past; when the system is implemented as a credit investigation system, the specified case may be an object of credit investigation; when the system is implemented as a driving support system, the specified case may relate to driving of a vehicle; or when the system is implemented as a business support system, the specified case may be business results.

As illustrated in FIG. 1, a data analysis system 1 according to this embodiment may include, for example, a server apparatus 2 capable of executing main processing of the data analysis, one or more client devices 3 capable of executing related processing of the data analysis, a storage system 5 equipped with a database 4 for recording data and evaluation results of the data, and a management computer 6 for providing the client device(s) 3 and the server apparatus 2 with a management function for the data analysis.

The client device (input control device) 3 can present part of a plurality of pieces of evaluation data or another data which is different from the evaluation data, as sample data before classification to a user (reviewer). Accordingly, the user can perform input (give the classification information) for evaluation and classification to the sample data via the client device 3. The server apparatus 2 can perform random sampling of a plurality of pieces of evaluation data, extract a specified number of pieces of sample data, and provide a specified client device with the extracted sample data. The aforementioned another data may be, for example, data which is not included in the evaluation data that is an analysis object, and in which belongs to a data group with the same or similar specified event as or to that of the evaluation data.

The client device 3 includes, as hardware resources, for example, a memory, a controller, a bus, input-output interfaces (such as a keyboard and a display), and a communications interface. The communications interface connects the client device 3, the server apparatus 2, and the management computer 6 via a communication means using a specified network in a manner capable of communications.

The artificial intelligence activated by control resources and storage resources of the server apparatus 2 learns patterns (which widely indicate, for example, abstract rules, meanings, concepts, forms, distributions, and samples included in data and are not limited to a so-called “specific pattern”) from the relevant learning data on the basis of the sample data to which the classification information is assigned, that is, a combination of the sample data and the classification information (hereinafter referred to as the “learning data”), and evaluates the relation between the evaluation data and the specified event on the basis of the relevant patterns. As the reviewer continuously gives the learning data to the artificial intelligence, the artificial intelligence grows by further learning the patterns. The phrase “the artificial intelligence grows” may mean that the performance of the relevant artificial intelligence enhances, for example, the accuracy of the artificial intelligence to evaluate the relation between the evaluation data and the specified event enhances.

The artificial intelligence can evaluate the relationship between the evaluation data and an illicit act (such as information leakage) on the basis of the above-described learned patterns, evaluate the relation between the evaluation data and a lawsuit, evaluate the relation between the evaluation data and criminal investigation, evaluate the relation between the evaluation data and the user's tastes, and evaluate the relation between the evaluation data and another arbitrary event (a specified event).

The server apparatus 2 may include, as hardware resources, for example, a memory, a controller, a bus, an input-output interface, and a communications interface in the same manner as the client device 3. When the evaluation data are e-mails, the evaluation data may be stored, for example, continuously or periodically from a mail server, which is not shown in the drawing, into the database 4 of the storage system 5.

The management computer 6 executes specified management processing on the client device 3, the server apparatus 2, and the storage system 5. The management computer 6 may include, as hardware resources, for example, a memory, a controller, a bus, an input-output interface, and a communications interface in the same manner as the client device 3. Incidentally, the memory included in each of the client device 3, the server apparatus 2, and the management computer 6 stores application programs capable of controlling each device; and as each controller executes the relevant application programs, the application programs (software resources) and hardware resources cooperate with each other and each device thereby operates.

The storage system 5 may be composed of, for example, a disk array system and include the database 4 for recording data and evaluation and classification results of the data. The server apparatus 2 and the storage system 5 are connected by a DAS (Direct Attached Storage) system or a SAN (Storage Area Network).

Incidentally, the hardware configuration illustrated in FIG. 1 is only for illustrative purposes and the above-described system can be implemented also by other hardware configurations. For example, the following configurations may be possible: a configuration in which part or whole of processing executed at the server apparatus 2 is executed at the client device 3; a configuration in which part or part or whole of such processing is executed at the server apparatus 2; or a configuration in which the storage system 5 is incorporated into the server apparatus 2. Furthermore, the user can not only perform input for evaluation and classification (or give the classification information) to the sample data via the client device 3, but also perform the above-described input via an input device directly connected to the server apparatus 2. Those skilled in the art understand that various hardware configurations capable of implementing the system can exist; and the hardware configuration is not limited to one specific configuration (such as the configuration illustrated in FIG. 1).

### Predictive Coding Function of Data Analysis System 1

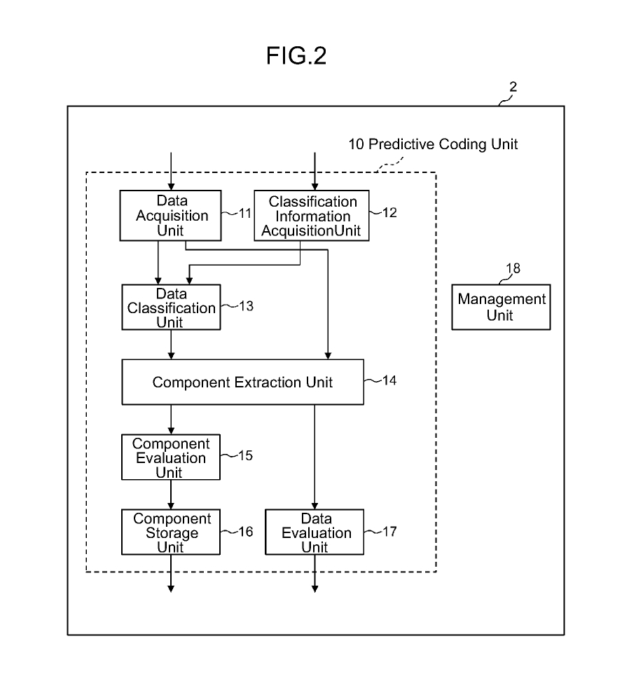

FIG. 2 is a functional block diagram illustrating an example of a predictive coding function implemented by the data analysis system (the server apparatus 2) according to this embodiment. The predictive coding function is one of major functions for the data analysis by the artificial intelligence.

### Basic Structure of Predictive Coding Function

The artificial intelligence includes a predictive coding unit 10 as illustrated in FIG. 2. The predictive coding unit 10 evaluates the evaluation data, for example, by scoring the evaluation data so that significant information can be extracted from a large amount of data (the evaluation data to which the classification information is not associated, such as big data) on the basis of a small amount of manually classified data (the aforementioned learning data).

The predictive coding unit 10 can include, for example, a data acquisition unit 11, a classification information acquisition unit 12, a data classification unit 13, a component extraction unit 14, a component evaluation unit 15, a component storage unit 16, and a data evaluation unit 17.

The data acquisition unit 11 acquires data from an arbitrary storage resource (such as the database 4, a web server on the Internet, or a mail server on the intranet). The data acquisition unit 11 provides the entire data, which is an object of the data analysis, as the evaluation data to the component extraction unit 14, acquires a specified amount of sample data, and provides it to the data classification unit 13.

The classification information acquisition unit 12 acquires the classification information input to each piece of the sample data by the user from an arbitrary input device (such as the client device 3) and outputs the classification information to the data classification unit 13.

The data classification unit 13 combines the plurality of pieces of sample data transmitted from the data acquisition unit 11 and the classification information input to each piece of the sample data from the classification information acquisition unit 12 and outputs such combination as a plurality of pieces of learning data to the component extraction unit 14.

The component extraction unit 14 extracts components, which constitute the plurality of pieces of learning data received from the data classification unit 13, from such learning data. Under this circumstance, the “components” may be partial data constituting at least part of the data and may be, for example: morphemes, keywords, sentences, paragraphs, and/or metadata (such as header information of e-mails) which constitute documents; partial voices, volume (gain) information, and/or tone information which constitute voices; partial images, partial picture elements, and/or brightness information which constitute images; and frame images, motion information, and/or three-dimensional information which constitute videos. The component extraction unit 14 outputs the extracted components and the classification information corresponding to the components to the component evaluation unit 15. Furthermore, the component extraction unit 14 extracts components, which constitute the evaluation data input from the data acquisition unit 11, from such evaluation data and outputs the components to the data evaluation unit 17.

The component evaluation unit 15 evaluates the components input from the component extraction unit 14. The component evaluation unit 15 evaluates, for example, the degree of contribution to the above-described combination by each of the plurality of components constituting at least part of the learning data (in other words, disbribution in which the components appear according to the classification information). More specifically, the component evaluation unit 15 calculates an evaluation value of the relevant component by evaluating the component by using, for example, a transmitted information amount (for example, an information amount calculated according to a specified definitional equation by using appearance probability of the component and appearance probability of the classification information). Accordingly, the component evaluation unit 15 can learn patterns included in the learning data (or learn patterns which characterize the learning data according to the classification information assigned by the user's input). The component evaluation unit 15 outputs the component and the evaluation value of the component to the component storage unit 16.

The component storage unit 16 associates the component with the evaluation value, which have been input from the component evaluation unit 15, and stores both of them in an arbitrary memory (such as the storage system 5).

The data evaluation unit 17 reads the evaluation value, which is associated with the component input from the component extraction unit 14, from the arbitrary memory (for example, the database 4 of the storage system 5) and evaluates the evaluation data on the basis of the relevant evaluation value. More specifically, the data evaluation unit 17 can derive an index (which may be, for example, a numerical value, letter, and/or sign capable of ranking the evaluation data) of the evaluation data by, for example, summing up evaluation values associated with components constituting at least part of the evaluation data the evaluation data. A preferred form of the index is a score obtained by summing up the evaluation values. The data evaluation unit 17 associates the evaluation data with the index and stores both of them in the arbitrary memory (such as the storage system 5).

The component evaluation unit 15 can select a component, repeatedly evaluate the relevant component, and modify the evaluation value of the relevant component until the evaluation of the data, to which the label “Related” or “High” is set becomes higher than the evaluation of the data to which these labels are not set. Consequently, the component evaluation unit 15 can find a component which appears in the plurality of pieces of learning data, to which the classification information “Related” or “High” is assigned, and influences the combination of the data and the label. The component evaluation unit 15 calculates an evaluation value wgt of a component by using, for example, the following expression.

wgt_{i,L}=\sqrt{wgt²_{L-i}+γ_{L}wgt²_{i,L}−θ}=\sqrt{wgt²_{i,L}+Σ^{L}ₗ₌₁(γ_{L}wgt²_{i,L}−θ)} [Math. 1]

In this expression, wgt represents an initial value of the evaluation value of an i-th component before evaluation. Furthermore, wgt represents the evaluation value of the i-th component after L-th evaluation; γ represents an evaluation parameter for L-th learning; and θ represents a threshold value of the evaluation. Consequently, the component evaluation unit 15 can evaluate the component as expressing its characteristics of the specified classification information more, for example, when the value of the calculated transmitted information amount is larger. Incidentally, the component evaluation unit 15 can set an intermediate value between the lowest value of the index of the learning data, to which “Related” is set, and the highest value of the index of the learning data, to which “Non-Related” is set, as a threshold value (specified reference value) used when automatically judging whether “Related” is set to the evaluation data or not. Then, the data evaluation unit 17 calculates the score of each of the plurality of pieces of evaluation data and each of the plurality of pieces of learning data by using the evaluation value of the component according to, for example, the following expression. The score is an index for quantitatively evaluating linkage strength of the above-mentioned data to a classification code. The data evaluation unit 17 can compare the score of each piece of the evaluation data with a specified reference value and classify the evaluation data equal to or more than the reference value as “Related” and classify the evaluation data less than the reference value as “Non-Related.”

Scr=Σ^{N}ᵢ₌₀i*(mᵢ*wgt²ᵢ)/Σ^{N}ᵢ₌₀i*wgt²ᵢ [Math. 2]

mj: appearance frequency of i-th component

wgti: evaluation value of i-th component

Incidentally, the configuration described as “XXX unit(s)” in the above explanation is the functional configuration(s) of the aritifical intelligence which is implemented by execution of a program (data analysis program) by the controller for the server apparatus 2, so that the “XXX unit” may be substituted with “XXX processing” or a “XXX function(s).” Moreover, since the “XXX units” can be also substituted with hardware resources, those skilled in the art understand that these functional blocks can be implemented by only hardware, only software, or a combination of the hardware and the software in various ways and are not limited to any one of them.

### Processing Executed by Predictive Coding Unit 10

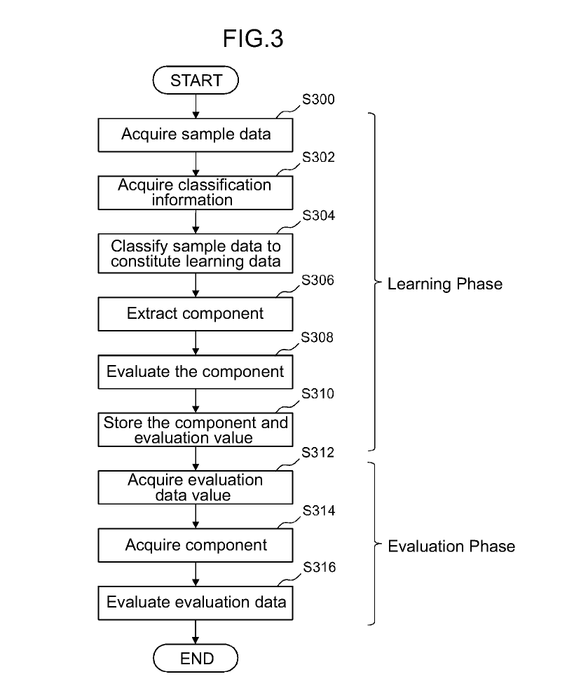

FIG. 3 is a flowchart illustrating an example of processing executed by the predictive coding unit 10 included in the data analysis system according to this embodiment.

Firstly, the data acquisition unit 11 acquires the sample data from the arbitrary memory (step 300; “Step” shall be hereinafter abbreviated as “S”). Next, the classification information acquisition unit 12 acquires the classification information which is determined by the user by actually reviewing the sample data and determining its classification, and is input to the sample data by the user, from the arbitrary input device (S302). Then, the data classification unit 13 constructs the learning data by classifying the sample data by combining the sample data and the classification information (S304) and the component extraction unit 14 extracts components, which constitute the learning data, from such learning data (S306). Then, the component evaluation unit 15 evaluates the components (S308) and the component storage unit 16 associates the components with the evaluation values and stores both of them in the arbitrary memory (S310). Incidentally, the above-described processing from S306 to S310 is called a “learning phase” (a phase in which the artificial intelligence learns patterns).

The data acquisition unit 11 acquires the evaluation data from the arbitrary memory (S312). The component extraction unit 14 extracts components, which constitute the evaluation data, from such evaluation data (S314). The data evaluation unit 17 reads the evaluation values associated with the relevant components from the arbitrary memory and evaluates the evaluation data on the basis of the evaluation values (S316). Incidentally, the above-described processing from S312 to S316 is called an “evaluation phase” (the artificial intelligence evaluates the evaluation data on the basis of the above-described patterns). It should be noted that each processing included in the above-described learning phase is not indispensable processing. For example, a memory which stores the components and the evaluation values of such components by associating them with each other may be provided in advance and the predictive coding unit 10 can evaluate the evaluation data on the basis of the components and the evaluation values which are stored in the memory.

Next, miscellaneous functions that the data analysis system according to this embodiment can execute by using the evaluation results of the predictive coding unit 10 will be explained. Such miscellaneous functions are executed by the management unit 18 (FIG. 2) for the server apparatus 2. One of these miscellaneous functions is a function visualizing the growth process of the artificial intelligence. Conventionally, there has been no means available for users of the data analysis system to check the growth process of the artificial intelligence. So, if an e-mail monitoring system is taken as an example of the data analysis system, it has been impossible to know to what degree the e-mail monitoring by the artificial intelligence is functioning, or how long it would take for the system to become active as a practical monitoring tool after starting the operation. The data analysis system can enhance the trust of the users on the data analysis (such as mail monitoring) by presenting the growth process of the artificial intelligence to the users.

### Visualization of Growth Process of Artificial Intelligence

For example, when the operation of the data analysis system is started, the management computer 6 can request the server apparatus 2 to execute processing for visualizing the growth process of the artificial intelligence. After the server apparatus 2 receives the request, the management unit 18 activates a visualization program to visualize the growth process of the artificial intelligence.

The management unit 18 can measure the growth of the artificial intelligence, create visualization information, as report information, about the growth process of the artificial intelligence on the basis of measurement results, and display it on at least one of the client device 3, the server apparatus 2, and the management computer 6 by means of the visualization program. As an unlimited aspect, a point for measuring the growth of the artificial intelligence is whether or not documents which are judged improperly by an auditor who is a reviewer to be “Related” (such as e-mails), or documents which are judged improperly to be “Non-Related” are properly scored by the artificial intelligence. The degree of growth of the artificial intelligence can be measured according to, for example, movements, background, and progress of factors which reflect the growth status of the artificial intelligence in learning, indicating at which positions scores of documents judged by the auditor to check whether they are related or not are distributed in scores of all the documents, and how scoring changes chronologically (along the growth process of the artificial intelligence). The growth process of the artificial intelligence can be divided into stages, that is, an initial growth period, a growth period, and a mature period in a typical example. The user can confirm that the data analysis system operates stably, by indicating that the growth of the artificial intelligence has reached the growth period and/or the mature period.

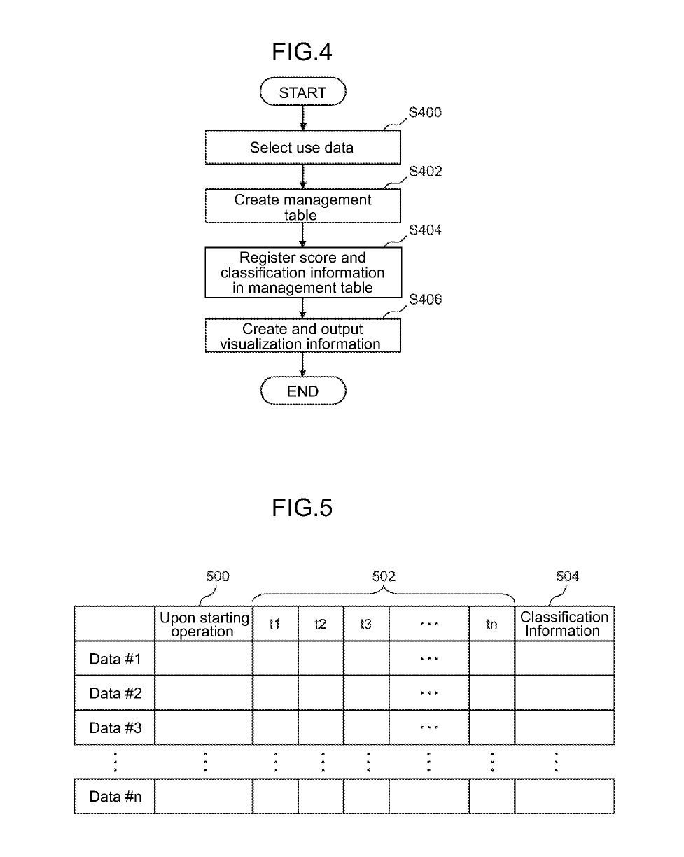

FIG. 4 is a flowchart illustrating the operation of the visualization program. The management unit 18 selects a specified number of pieces of evaluation data from among the evaluation data scored in a stage where the operation of the data analysis system is started (a stage where the artificial intelligence is created), as data to be used to visualize the growth process of the artificial intelligence (hereinafter referred to the “use data”) (S400). The use data is used to display time-series changes in the distribution of the scores along with the growth of the artificial intelligence and, therefore, the specified number may be a necessary number to indicate the distribution of the scores to the user. For example, the specified number may be selected from the range from several tens to several thousands. The management unit 18 can select the use data randomly or according to requirements designated by an administrator (for example, whether the data is e-mails related to a certain department within a company). The management unit 18 should select the use data in a well-balanced manner from the evaluation data of high scores to the evaluation data of low scores without being biased toward to either the high or low scores. The learning data may be also used as the use data.

Next, the management unit 18 creates a management table of the use data and registers the calculated scores in the management table (S402). FIG. 5 is an example of the management table. The management unit 18 registers scores at the time of start of the system's operation in an area 500 with respect to each of a plurality of use data (data #1 to data #n). Furthermore, the management unit 18: demands that the reviewer should actually review each piece of the use data and assign the aforementioned classification; and registers the classification information of each piece of the use data in an area 504 (S404).

In the process of progress of the data analysis system's operation, the management unit 18 evaluates the use data (S17 and S18) at specified intervals, for example, at regular timings (time points) and sequentially records scores calculated at respective timings in an area 502 of the management table. Each of t1, t2, t3, and so on up to tn is such timing. The regular timing may be, for example, every several days or every week and has no limitations. Alternatively, the timing may be arbitrary timing designated by the system administrator. Since the artificial intelligence grows in accordance with the operation of the system, a score of even the same data will change as influenced by the growth degree of the artificial intelligence, depending on at which time point the score is calculated.

Since the scores of the use data are influenced by the growth of the artificial intelligence, for example, the growth degree of the artificial intelligence can be recognized from aspects of the scores such as distribution of the scores and changes in the distribution. As the management unit 18 displays the aspects of the distribution of the scores in a specified form with respect to the use data, it is possible to show the user which stage of growth the artificial intelligence is in.

When the management unit 18 receives a request from the user to visualize the growth process of the artificial intelligence via the management computer 6, it accesses the management table (FIG. 5), reads the score of each piece of the use data, creates the visualization information, and outputs it via an output means (such as a display device) of, for example, the server apparatus 2 (S406).

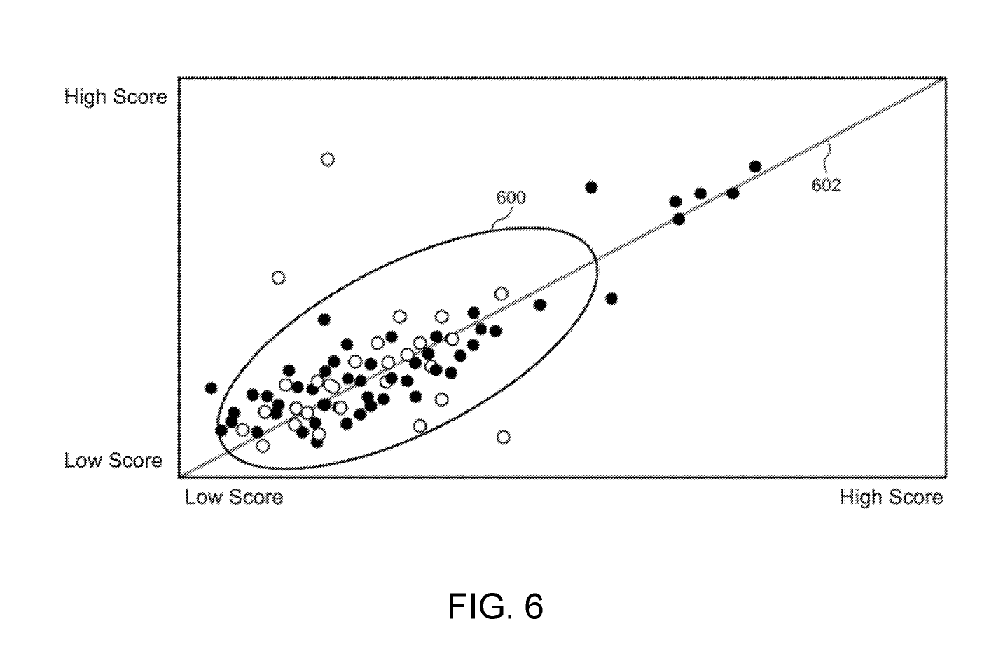

FIG. 6 is a graph illustrating the distribution of scores of a plurality of pieces of data, which is an example of the visualization information, in accordance with the operation of the system. The vertical axis represents the scores of the use data which are calculated at a first time point; and the horizontal axis represents scores of the use data which are calculated at a second time point later than the first time point. The first time point and the second time point may be selected arbitrarily from the management table (FIG. 5); however, for example, as explained below, the horizontal axis represents scores at the latest time point or at the present time point and the vertical axis represents scores at the immediately preceding time point.

Each one of marks ∘ or corresponds to each piece of the use data. The mark ∘ represents that it is data classified as “Non-Related” by the reviewer; and the mark represents that it is data classified as “Related” by the reviewer. FIG. 6 is a typical example of the score distribution in the initial operation stage of the data analysis system. Since the artificial intelligence has not grown sufficiently yet in the initial operation stage, the artificial intelligence may assign a low score to even data which is judged as “Related” by the reviewer. So, there is divergence between the reviewer's judgment and the artificial intelligence's judgment (score). As a result, the scores tend to become low through the entire graph and ∘ and coexist and are mixed together (as indicated with reference numeral 600) in a lower left area of the graph. Reference numeral 602 represents a reference line indicating that a score on the horizontal axis (a score calculated at the latest timing) and a score on the vertical axis (a score calculated at the immediately preceding timing in the past) are the same. Since the artificial intelligence has not grown in the initial stage after the start of the operation of the data analysis system, scores do not change much even when they are calculated at different timings; and the scores tend to be distributed intensively around the reference line.

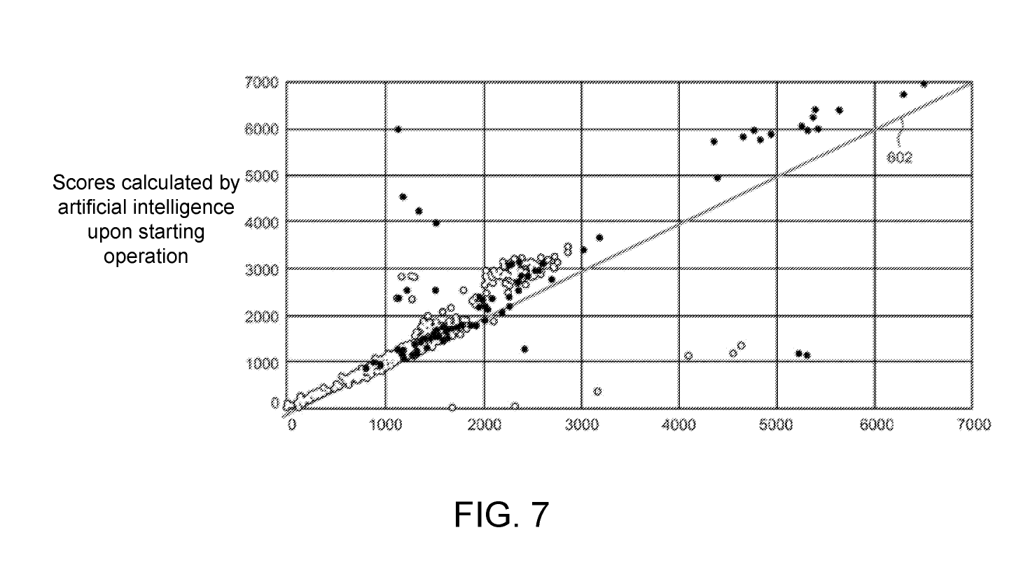

FIG. 7 is a graph illustrating the score distribution of the use data relating to an actual example when the data analysis system is still in early days of the operation with respect to the aforementioned visualization information after the operation is started. The vertical axis represents a score at the time of start of the operation and the horizontal axis represents a score at a time point 10 days after the start of the operation. Referring to FIG. 7, the same tendencies can be observed as those in the graph of FIG. 6, that is, for example, scores are distributed intensively on the lower left side of the graph and the related data () and the non-related data (∘) coexist and are mixed together. So, the user can judge, at the time point 10 days after the start of the system's operation, that the artificial intelligence is in a state of not having grown yet (the initial growth period).

Then, as the operation of the data analysis system proceeds and the amount of data analyzed by the reviewer increases, the artificial intelligence continues to learn and the growth of the artificial intelligence advances. So, the data judged by the reviewer to be “Related” tends to receive high scores. Therefore, regarding the score distribution of the “Related” data, scores calculated at the timing in the past become low and scores calculated at the latest timing become high, which means that the scores move to a lower right zone. On the other hand, regarding the distribution of “Non-Related” data, the scores in the past are high and the latest scores move to a lower zone, that is, an lower left zone.

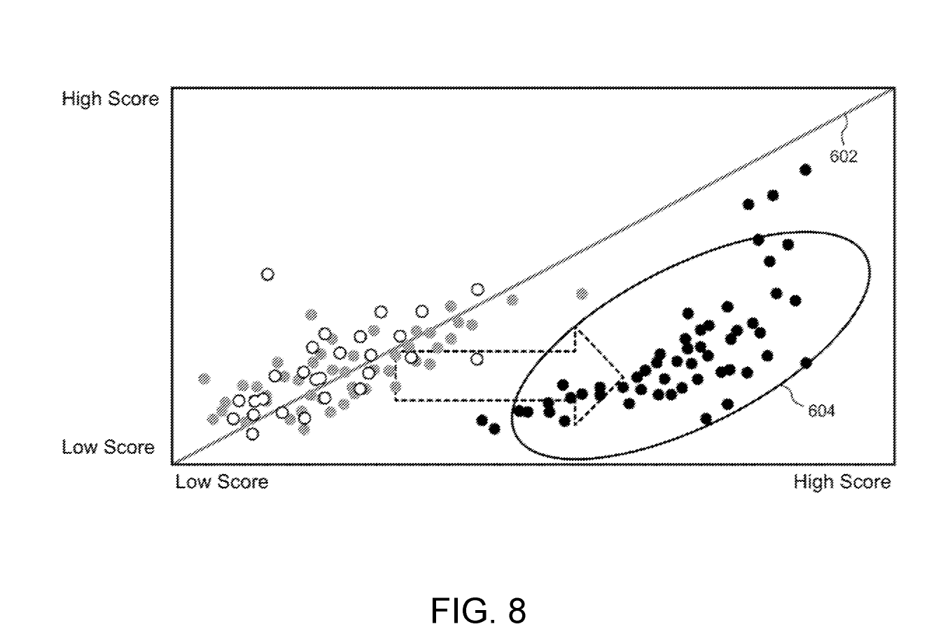

FIG. 8 is a graph relating to a typical example of the data score distribution during the growth period of the artificial intelligence. While the distribution of scores for the “Related” data whose scores in the past were high remain high, the distribution of latest scores of the “Related” data whose scores in the past were low becomes high. Regarding this score distribution of the “Related” data as compared to the distribution of the initial operation period, the scores tend to move out of the co-existing area (which is indicated with the reference numeral 600 in FIG. 6) towards an area 604 on the lower right side of the reference line 602, thereby separating the data into the distribution of the scores for the “Related” data and the distribution of the scores for the “Non-Related” data.

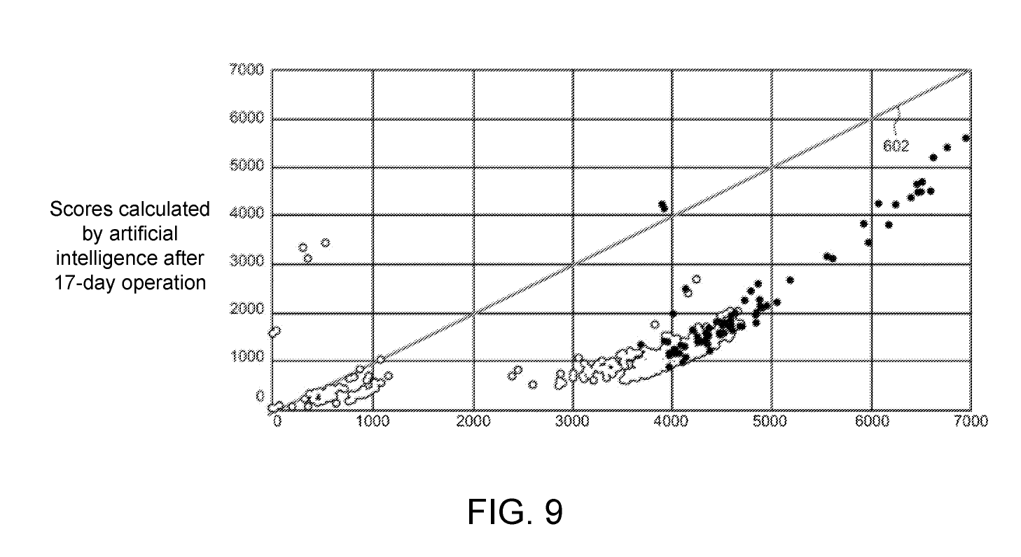

FIG. 9 is a graph illustrating the score distribution of the use data as the aforementioned visualization information in an actual example where the operation of the system has advanced from the operation stage illustrated in FIG. 7. The vertical axis represents a score at a time point 17 days after the start of the system's operation and the horizontal axis represents a score at a time point 24 days after the system's operation. Referring to FIG. 9, the same tendencies can be observed as those in the graph of FIG. 8, so that the user can judge, at the time period 24 days after the start of the system's operation, that the artificial intelligence is in the growth period in which it learns and grows actively.

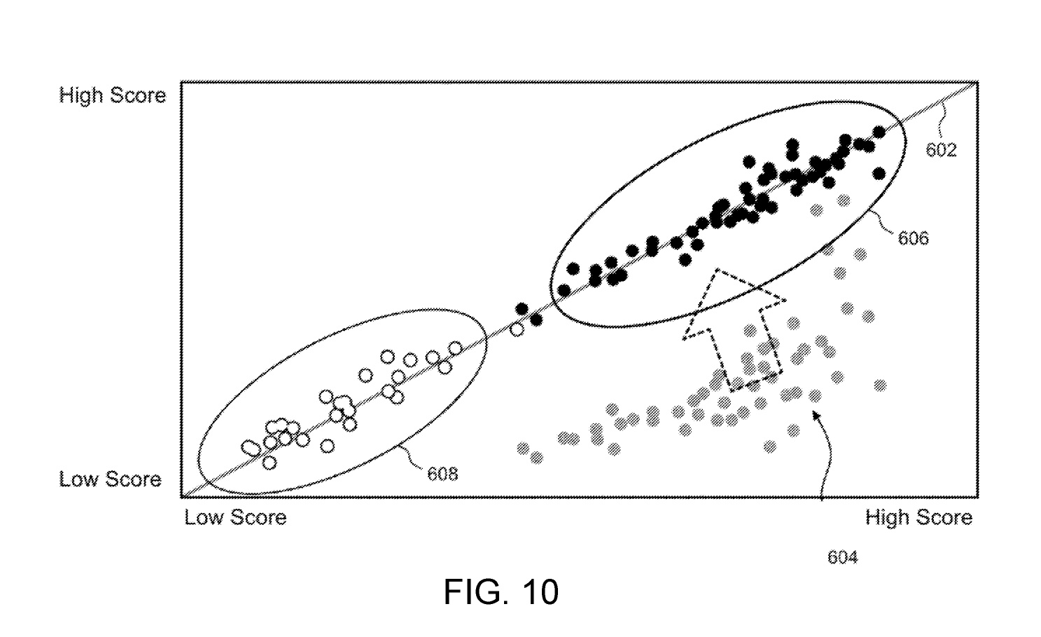

As the operation of the system further proceeds and the amount of data analyzed by the reviewer increases, the artificial intelligence further continues learning and the growth of the artificial intelligence tends to become stable. FIG. 10 is a graph relating a typical example of the data score distribution when the growth of the artificial intelligence is in the mature period. In a state where the growth of the artificial intelligence is stable, there is not much difference in the growth degree of the artificial intelligence between the timing in the past and the latest timing. So, there will be less difference between the past score and the latest score of the same data and the scores of the data will be distributed along the reference line.

In the process where the artificial intelligence proceeds from the growth stage and reaches the mature period, the score distribution of the use data classified as “Related” moves from the area 604 on the lower right side of the graph to a high score area 602 on the upper right side towards the reference line 602, and the score disbribution of the use data classified as “Non-Related” moves to a low score area 608 on the lower left side of the reference line 602, so that these score distributions are separated. The fact that the data score distributions have entered this state means that learning of the artificial intelligence has progressed ideally; and indicates that the growth of the artificial intelligence has entered a mature state.

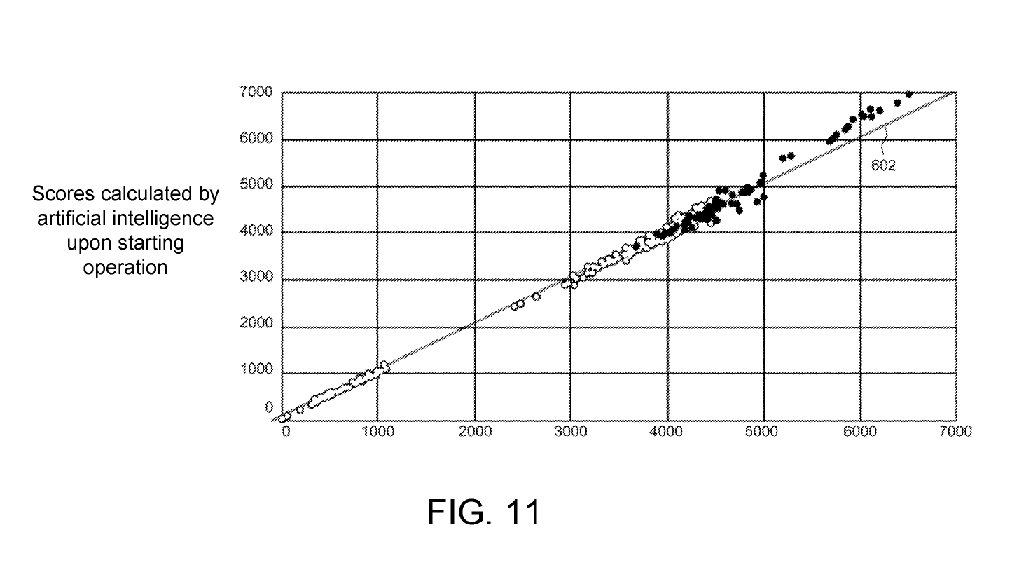

FIG. 11 is a graph illustrating the score distribution of the use data as the aforementioned visualization information in an actual example where the operation of the system has further advanced from the stage illustrated in FIG. 9. The vertical axis represents a score at a time point 24 days after the start of the operation and the horizontal axis represents a score at a time point 29 after the start of the operation. Referring to FIG. 11, the same tendencies can be observed as those in the graph of FIG. 10, so that the user can judge, at the time period 29 days after the start of the system's operation, that the artificial intelligence is in the mature period where the growth has become stable.

It has been explained that the data analysis system outputs the aforementioned visualization information and entrusts a person to judge which phase the growth of the artificial intelligence is in; however, the data analysis system may judge which phase the growth of the artificial intelligence is in, by recognizing the aforementioned characteristics from the aforementioned visualization information.

It has been explained that the data evaluation unit 17 compares a score of each piece of the evaluation data with a specified reference value, classifies the evaluation data, which is equal to or more than the reference value, as “Related,” and classifies the evaluation data, which is less than the reference value, as “Non-Related”; however, it is difficult to specifically determine the “reference value.” However, according to the visualization information regarding the growth stage of the artificial intelligence, there is a tendency that the location of the data classified as “Related” and the location of the data classified as “Non-Related” are separated along the reference line and they are clearly divided in the mature stage of the artificial intelligence. Therefore, a score at their boundary may be set as the reference value.

The above explanation has described the visualization information so that the distribution of the scores of the “Related” data and the scores of the “Non-Related” data is formed two-dimensionally with respect to the past timing and the latest timing; and such distribution changes depending on the stages of the growth process of the artificial intelligence and such changes allow the user to understand the growth process of the artificial intelligence; however, the visualization information is not limited to this example. For example, there is a second embodiment of the visualization information as follows.

In the stage where the growth of the artificial intelligence is progressing, the distributions of both the scores of the “Related” data and the scores of the “Non-Related” data tend to diverge from the reference line; and as the growth of the artificial intelligence becomes stable, these distributions tend to be located closer to the reference line. In the stage where the growth of the artificial intelligence has matured, these distributions tend to be located along the reference line. Therefore, the growth stage of the artificial intelligence can be judged by calculating the divergence from a distributed position of the data relative to the reference line (the vertical-direction distance from the distributed position of the data relative to the reference line) with respect to each piece of the data and using the displayed tendency of the divergence as the visualization information.

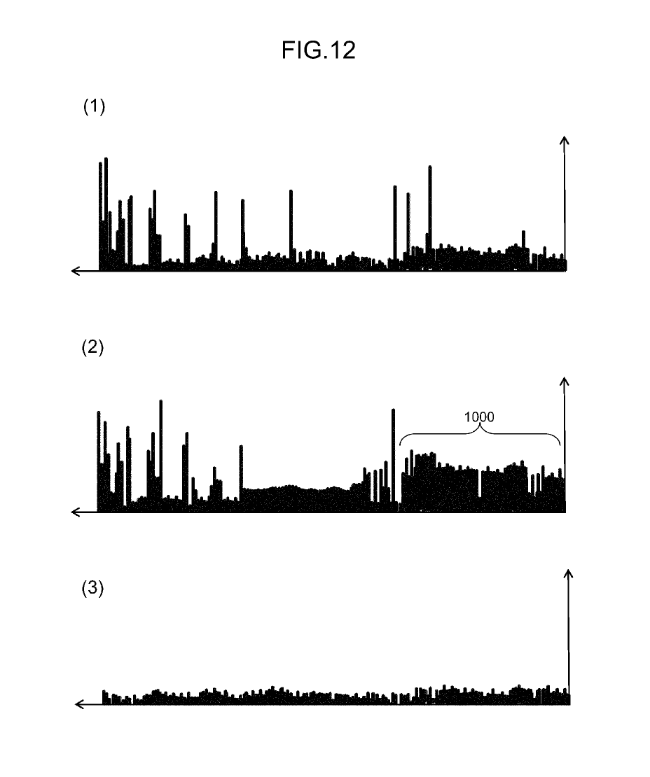

FIG. 12 is graphs showing the relation between the use data and the divergence for each growth stage of the artificial intelligence in the aforementioned actual examples. FIG. 12 (1) is a graph corresponding to the initial operation stage of the artificial intelligence; (2) is a graph corresponding to the progressing growth stage of the artificial intelligence; and (3) is a graph corresponding to the stable growth stage of the artificial intelligence. The horizontal axis represents each piece of the use data (however, in descending order of scores at the latest timing); and the vertical axis represents the divergence. In (1) at the time of start of the artificial intelligence's operation, the artificial intelligence has not grown, so that the divergence is generally low and the divergence of the use data is sometimes large at some locations. In the stage where the artificial intelligence is actively growing, the divergence of the use data is large and, particularly, the divergence of the use data with high scores increases (1000). Then, in the stage where the growth of the artificial intelligence has become stable, there is a tendency that the difference between the scores decreases depending on the difference in the score calculation timing, thereby causing the divergence to become smaller.

Furthermore, there is a third embodiment of visualization as described below. In the stage where the growth of the artificial intelligence is progressing, a score of the data can change considerably every time the score is calculated. So, both the distribution of scores of the “Related” data and the distribution of scores of the “Non-Related” data move significantly over the two-dimensional coordinates. On the other hand, in the stage where the growth of the artificial intelligence has matured, a score of the data does not change so much every time the score is calculated. So, both the distribution of scores of the “Related” data and the distribution of scores of the “Non-Related” data tend to not move so much. Therefore, the growth stage of the artificial intelligence can be judged by calculating the distance by which the disbribution of the score at a time point in the past has moved to the disbribution of the score at the latest time point and using the displayed tendency of the moving distance as the visualization information.

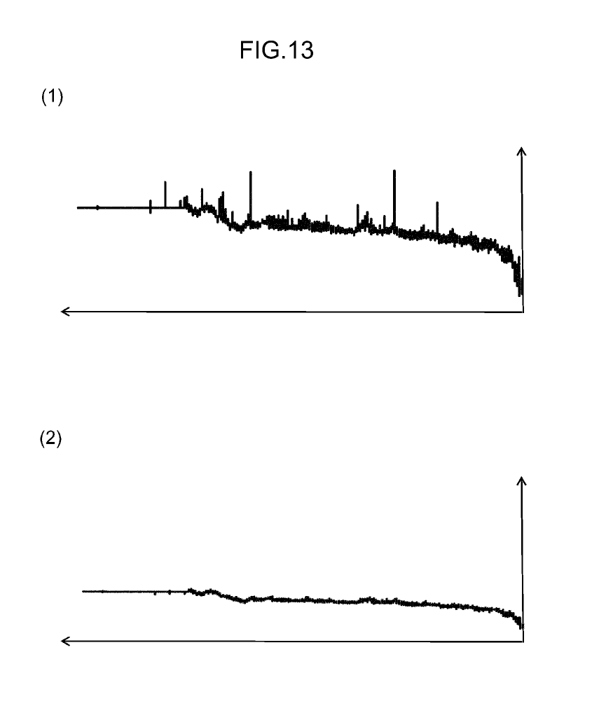

FIG. 13 is graphs showing the relation between the use data and the moving distance for each growth stage of the artificial intelligence in the aforementioned actual examples. FIG. 13 (1) is a graph corresponding to time from the initial operation stage of the artificial intelligence to the stage where the growth of the artificial intelligence is progressing; and (2) is a graph corresponding to time from the stage where the growth of the artificial intelligence is progressing to the stage where the growth of the artificial intelligence has become stable. The horizontal axis represents each of the use data (however, in a descending order of scores at the latest timing); and the vertical axis represents the moving distance. From the start of the operation of the artificial intelligence until the stage where its growth is progressing, the value of a score changes relatively considerably every time the score of the use data is calculated, so that the moving distance increases; and from the stage where the growth of the artificial intelligence is progressing until the stage where the growth of the artificial intelligence has become stable, the value of a score does not relatively change so much every time the score of the use data is calculated, so that the moving distance decreases.

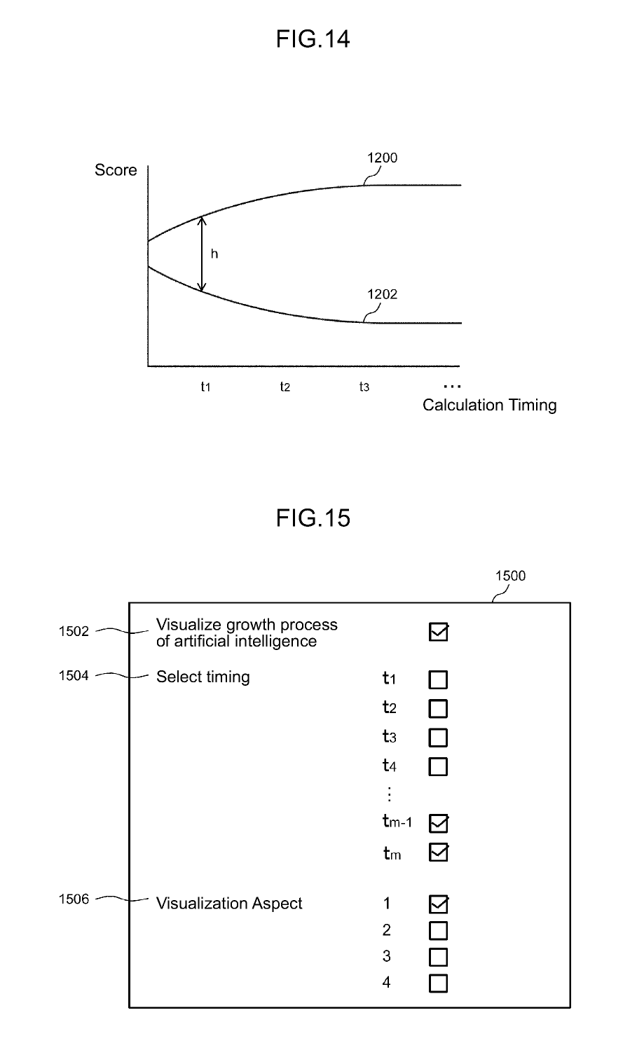

Furthermore, there is a fourth embodiment of visualization as described below. In the initial stage of the growth of the artificial intelligence, the distribution of scores of the “Related” data and the distribution of scores of the “Non-Related” data co-exist and are mixed as mentioned earlier, so that there is a tendency that the difference between the former data (for example, an average value of the plurality of pieces of the “Related” data) and the latter data (for example, an average value of the plurality of pieces of the “Non-Related” data) is small. As the growth of the artificial intelligence advances, this difference tends to expand. Then, in the stage where the artificial intelligence has matured, this tendency of expanding the difference decreases and the difference between the former data and the latter data will not change even if the operation of the data analysis system proceeds. So, the growth stage of the artificial intelligence can be judged by visualizing the tending of changes in the difference between the former data and the latter data. FIG. 14 is a graph showing the tendency of the difference between the former data and the latter data; the horizontal axis represents the score calculation timing and the vertical axis represents scores; and 1200 represents an average value of scores of a “Related” data group and 1202 represents an average value of scores of a “Non-Related” data group. FIG. 14 shows that as the operation of the data analysis system proceeds, the difference (h) between the scores of the “Related” data and the scores of the “Non-Related” data gradually expands and then the expansion of the difference reduces.

The user of the data analysis system can recognize the growth process of the artificial intelligence by visualizing the growth process of the artificial intelligence in a specified form on the basis of the difference between the distributions of the scores for each of the plurality of pieces of the use data at a specified score calculation timing and at a score calculation timing before that as described above, so that reliability of the data analysis is enhanced.

FIG. 15 is an example of a management screen 1500 for visualizing the growth process of the artificial intelligence. The management screen includes graphical user interfaces (GUI) indicated with 1502, 1504, and 1506. A first GUI 1502 is designed for the user to select whether it is necessary to visualize the growth process of the artificial intelligence or not when starting the operation of the data analysis system by the artificial intelligence. A second GUI is designed to enable the user to select the score calculation timing when obtaining the distribution of the scores of the use data in order to visualize the growth process of the artificial intelligence. TO is the timing when a score is calculated upon the start of the system's operation and tm is the latest score calculation timing. A specified number of timings may be selected from these pluralities of timings; however, the latest timing (tm) and the timing immediately before it (tm−1) should preferably be selected in order to check the progress of the growth of the artificial intelligence. A third GUI is designed for the user to select an aspect of visualization of the growth process of the artificial intelligence. As for the aspect of visualization, there are the first aspect to the fourth aspect as described earlier.

### Pattern Update Function

The predictive coding unit 10 can optimize evaluation values of components on the basis of specified learning data and/or newly acquired learning data as described in, for example, (1) to (3) below.

### (1) Optimization of Evaluation Value

The component evaluation unit 15 can update the aforementioned learned pattern by calculating a recall rate or a precision rate on the basis of an evaluation result of the evaluation data and repeatedly evaluating the degree of the components' contribution to the combination of the data and the classification information in order to increase the recall rate or the precision rate.

Under this circumstance, the above-described “recall rate” (Recall Rate) is an index indicative of a proportion (comprehensiveness) of data to be discovered to a specified number of pieces of data. For example, when it is expressed as “the recall rate is 80% relative to 30% of the entire data,” it means that 80% of the data to be discovered is contained the index's top 30% of the data (it means that when all pieces of the data are reviewed (linear review) without using the data analysis system, the amount of data to be discovered is proportional to the reviewed amount; so, when the divergence from the proportion is larger, it means that the system exhibits better performance). Furthermore, the above-described “precision rate” (Precision Rate) is an index indicative of a proportion (precision) of the data to be truly discovered to data discovered by the above-described system. For example, when it is expressed that the precision rate is 80% at the time when 30% of the entire data has been processed, it means that the proportion of the data to be discovered to the index's top 30% of the data is 80%.

The component extraction unit 14 calculates the recall rate or the precision rate on the basis of the results evaluated by the data evaluation unit 17; and when the recall rate or the precision rate is less than a target value, the component extraction unit 14 re-extracts the components from the data until the recall rate or the precision rate exceeds the target value. When this happens, the component extraction unit 14 may extract components by excluding the components extracted last time or may substitute some of the components extracted last time with new components. Furthermore, when the data evaluation unit 17 derives the index for the evaluation data from the re-extracted components, it may derive an index (second index) for each piece of data by using the re-extracted components and their evaluation values and re-derive the recall rate or the precision rate from a first index obtained before re-extracting the components, and from the second index. As a result, the data analysis system can further have an additional advantageous effect capable of enhancing the accuracy of the data analysis.

### (2) Evaluation of Components by Convolution Method

After evaluating components included in the learning data, the component evaluation unit 15 can re-evaluate the relevant components by convoluting evaluation values of components other than the relevant components so that the evaluation values of the other components will be reflected in the evaluation values of the relevant components. Accordingly, the relation between the relevant components and the other components is evaluated as an evaluation value of the relevant components, so that the data analysis system can further have the additional advantageous effect capable of enhancing the accuracy of the data analysis.

### (3) Optimization Timing

The component evaluation unit 15 can update a pattern (for example, a combination of a component and the evaluation value of the relevant component) at arbitrary timing. Specifically speaking, the component evaluation unit 15 can update the above-described pattern, for example: (a) at the timing when receiving an update request from an administrative user who manages the above-described system; (b) at the timing when a preset date and time has arrived; and/or (c) at the timing when the user's input about an additional review is accepted.

The user can check (or perform a check review of) the content of the evaluation data, from which the index is derived by the data evaluation unit 17, and newly input classification information to the relevant evaluation data. When this happens, the classification information acquisition unit 12 may acquire the newly input classification information and the data classification unit 13 may combine the above-described evaluation data and the relevant classification information and use such combination as new learning data. Such new learning data is accumulated in an arbitrary memory and is fed back to the above-described system, for example, at the above-described timing (a) to (c).

Accordingly, the component extraction unit 14 extracts a component from the above-described new learning data and the component evaluation unit 15 evaluates the relevant component. When the relevant component was evaluated before and that component and its evaluation value are stored in the memory, the component storage unit 16 replaces the relevant evaluation value with a new evaluation result (evaluation value); and when they are not stored, the component storage unit 16 associates the relevant component with its evaluation value and newly stores them in the relevant memory. Specifically speaking, the predictive coding unit 10 can update the above-described learned pattern by re-evaluating the degree that a plurality of components constituting at least part of data corresponding to the relevant classification information contributes to the combination of the relevant data and the relevant classification information, at arbitrary timing (for example, at the above-described timing (a) and (b)). As a result, the data analysis system can further have the additional advantageous effect capable of enhancing the accuracy of the data analysis.

The management unit 18 can further execute the following (1) to (5).

### (1) Review Heat Map

Let us assume a case where the data evaluation unit 17 derives the index for each of the plurality of pieces of evaluation data (for example, in the order indicating that the relevant index shows a high relation between the relevant evaluation data and a specified event) and the user checks (performs the check review of) each of the plurality of pieces of evaluation data and assigns the classification information. When this happens, the management unit 18 can display the distribution of a proportion of the evaluation data, which is associated with the classification information, to the total evaluation data with respect to the evaluation result of each of the plurality of pieces of evaluation data in a visually recognizable manner by using gradations of the rate.

For example, when the data evaluation unit 17 derives a numerical value ranging from 0 to 10000 as the above-described index, the management unit 18 can classify the evaluation data into, for example, a range of the relevant index sectioned by every 1000 (that is, by setting 0 to 1000 as a first section, 1001 to 2000 as a second section, 2001 to 3000 as a third section, and so on) (for example, by classifying the evaluation data, whose the index is 2500, into the third section) and display a certain range by changing the tone of that range (for example, by making the tone closer to warm colors when the proportion described below is higher; and making the tone closer to cold colors when the proportion is lower) so that the proportion of the evaluation data, to which specified classification information (for example “Related”) is assigned, to the total amount of the evaluation data classified as the relevant range can be visually recognized. Regarding other ranges, the management unit 18 also display the other ranges in the same manner.

Accordingly, the management unit 18 can display the distribution of the above-described proportion in each range by using the gradations. So, for example, when the above-described proportion within the relevant range is indicated with the tone of cold colors even though the range regarding which the above-described index indicates that the relation between the evaluation data and the specified event is high (for example, the range is a ninth section for which the index is 8001 to 9000), it is possible to suggest that the check review by the user might be wrong. In other words, the data analysis system further has an additional advantageous effect capable of allowing the user to comprehend the distribution at a glance.

### (2) Central Linkage

The management unit 18 can visualize a correlation (such as a hierarchical relationship, a business affiliation relationship, or frequent or infrequent data transmissions and receptions) between a plurality of subjects (such as humans, organizations, and computers). For example, when a first computer sends an e-mail to a second computer, the management unit 18 can display a diagram, in which a first circle representing the first computer and a second circle representing the second computer are connected with an arrow extending from the first circle towards the second circle (for example, the arrow may have a width depending on whether e-mails are exchanged frequently or infrequently), on a specified display device (for example, a display of the client device 10).

Furthermore, the management unit 18 can visualize the above-described correlation according to the results evaluated by the data evaluation unit 17. For example, when the data evaluation unit 17 derives a numerical value ranging from 0 to 10000 as the above-described index, the management unit 18 can display the above-described diagram on the above-described specified display device, for example, on the basis of only the evaluation data associated with the index belonging to a designated section (for example, the e-mails sent from the first computer to the second computer). As a result, the data analysis system further has an additional advantageous effect capable of allowing the user to comprehend the correlation between the pluralities of subjects at a glance.

### (3) Behavior Extractor

The management unit 18 judges whether a first component indicative of a specified action is included in the evaluation data or not; and when the management unit 18 determines that the first component is included in the evaluation data, it can identify a second component indicative of an object of the specified action. For example, if a text stating “to determine specifications” is included in the above-described evaluation data, the management unit 18 extracts components “specifications” and “determine” from the text and identifies the other component (object) “specifications” which is the object of the component (verb) indicative of the specified action “determine.” Next, the management unit 18 associates meta-information (attribute information) indicative of attributes (characters and characteristics) of the evaluation data including the above-described component and the other component, with the relevant component and the other component. Under this circumstance, the above-described meta-information is information indicative of specified attributes of the data. For example, when the above-described evaluation data is an e-mail, the meta-information may be the name of a person who sent the relevant e-mail, the name of a person who received the e-mail, mail addresses, and transmission and reception dates and times.

Then, the management unit 18 associates the two components with the meta-information and displays them on the specified display device (for example, the display of the client device 3). For example, the management unit 18 can display a diagram, in which a circle representing the first component and a circle representing the second component are connected via an arrow extending from the first circle towards the second circle. As a result, the data analysis system further has an additional advantageous effect capable of allowing the user to comprehend the above-described specified action and its object at a glance.

### (4) Automatic Summarization Based on Generative Concept Extraction

The management unit 18 can extract data including components corresponding to a subordinate concept of a previously selected concept from each of the plurality of pieces of evaluation data and generate the content (such as texts, graphs, and charts) capable of summarizing the plurality of pieces of evaluation data.

Firstly, when the user selects some concepts according to a topic, which needs to be detected from the evaluation data, and registers the selected concepts in the management unit 18 in advance. For example, if the topic to be detected is “fraudulence” or “unsatisfaction,” the concept is divided into five categories “behaviors,” “emotions,” “characters and states,” “risks,” and “money”; and the user registers concepts of, for example, “revenge,” “despise,” and so on regarding the “behaviors,” “suffer,” “get angry,” and so on regarding the “emotions,” “obtuse,” “a bad attitude,” and so on regarding the “characters and states,” “threaten,” “deceive,” and so on regarding the “risks,” and “money to be paid for people's labor” and so on regarding the “money,” respectively, in the management unit 18.

The management unit 18 searches the learning data for the components corresponding to the subordinate concepts of the above-described concept with respect to each registered concept, associates the components found by the search with the concept, and stores them in an arbitrary memory (for example, the storage system 18). Then, the management unit 18 extracts the stored components from the evaluation data, identifies the concept associated with the components, and outputs a summary using the concept. For example, the management unit 18 extracts concepts “system,” “sale,” and “perform” from a text stating “receive orders for a monitoring system” included in a certain e-mail, extracts concepts “system,” “sale,” and “perform” from a text stating “introduction of an accounting system” included in another e-mail, and outputs “to perform sale of the system” as a summary of these e-mails. Under this circumstance, the management unit 18 can show, for example, a graph (such as a circle graph) illustrating a proportion of the evaluation data including the concept “to perform sale of the system” to all the pieces of evaluation data. As a result, the data analysis system further has an additional advantageous effect capable of allowing the user to comprehend the entire picture of the evaluation data.

### (5) Topic Clustering

The management unit 18 can cluster a plurality of pieces of evaluation data according to a topic (subject) included in the plurality of pieces of evaluation data. For example, the management unit 18 can cluster the plurality of pieces of evaluation data by using an arbitrary classification model (such as the K-means method, a support vector machine, or spherical surface clustering). As a result, the data analysis system further has the additional advantageous effect capable of allowing the user to comprehend the entire picture of the evaluation data.

### Auxiliary Functions

Each unit of the predictive coding unit 10 can have, for example, the following auxiliary functions (1) to (6).

### (1) High Resolution Evaluation

The data evaluation unit 17 can evaluate the evaluation data at high resolution. Specifically speaking, the data evaluation unit 17 can not only derive the index with respect to the evaluation data, but also can, for example, divide the evaluation data into a plurality of parts (for example, sentences or paragraphs [partial evaluation data] included in the relevant evaluation data) and evaluate each of the plurality of pieces of the partial evaluation data on the basis of the learned pattern (or derive an index for the partial evaluation data). Then, the data evaluation unit 17 can integrate a plurality of indexes derived for the plurality of partial evaluation data, respectively, and use the integrated index as the evaluation result of the evaluation data (for example, when each index is derived as a numerical value, it is possible to extract a maximum value of those indexes and use it as the integrated index for the relevant evaluation data, or use an average of the indexes as the integrated index for the relevant evaluation data, or sum up a specified number of the indexes in descending order and use the sum result as the integrated index of the evaluation data). As a result, the data analysis system can further have the additional advantageous effect capable of enhancing the accuracy of the data analysis.

### (2) Chronological Evaluation

When data whose characters change along with the elapse of time (such as electronic medical records in which medical conditions progressing along the elapse of time are recorded) is to be analyzed, the component evaluation unit 15 can learn a pattern of each piece of learning data which is sectioned at each specified time interval (for example, learning data of a first section, learning data of a second section, and so on) (that is, can acquire components and the evaluation results of such components at the each specified time interval); and the data evaluation unit 17 can evaluate the evaluation data on the basis of each of the patterns. In other words, the data evaluation unit 17 can derive indexes for the evaluation data in chronological order. As a result, the data analysis system can further have the additional advantageous effect capable of enhancing the accuracy of the data analysis.

When this happens, the data evaluation unit 17 can predict a future index on the basis of temporal changes of the above-described index. For example, the data evaluation unit 17 can predict the next index to be obtained when evaluating new evaluation data, on the basis of a model for time-series analysis (such as an autoregressive model or a moving-average model) and indexes derived for a specified period of time (for example, for the past one month), before obtaining the new evaluation data. As a result, the data analysis system can further have an additional advantageous effect capable of presenting an event which may possible happen in the future (such as a risk which may cause unfavorable circumstances) to the user.

### (3) Case-Based Evaluation

Data whose characters change depending on the types of cases (such as lawsuit-related documents whose content changes depending on the types of lawsuits [such as violations of the Antimonopoly Act, information leakage, and patent right infringements]) is to be analyzed, the component evaluation unit 15 can learn a pattern from each piece of learning data prepared for each case (for example, learning data about a violation of the Antimonopoly Act, learning data about information leakage, and so on) (that is, can obtain components and the evaluation results of the components for each case); and the data evaluation unit 17 can evaluate the evaluation data on the basis of each such pattern. As a result, the data analysis system can further have the additional advantageous effect capable of enhancing the accuracy of the data analysis.

### (4) Parsing

The data evaluation unit 17 can analyze the structure of the evaluation data and reflect the analysis result in the evaluation of the relevant evaluation data. For example, when the evaluation data at least partly includes sentences (texts), the data evaluation unit 17 can analyze an expression form of each sentence included in the relevant text (for example, whether the relevant sentence is affirmative, negative, or passive) and reflect the analysis result in the index derived for the evaluation data. Under this circumstance, the affirmative form is an expression which affirms the subject (for example, “food tastes good”), the negative form is an expression which negates the subject (for example, “food tastes bad” or “food does not taste good”), and the passive form may be an expression which euphemistically affirms or negates the subject (for example, “could not say the food was good” or “could not say the food was bad”).

The data evaluation unit 17 can adjust the index according to the above-described expression form. For example, when the data evaluation unit 17 derives a numerical value within a specified range as the above-described index, the data evaluation unit 17 can adjust the above-described index by, for example, adding “+α” to the affirmative form, adding “−β” to the negative form, and adding “+θ” to the passive form (each of α, β, and θ may be an arbitrary numerical value). Furthermore, when the data evaluation unit 17 detects that a sentence included in the evaluation data is negative, it can determine to not use components of that sentence (or to not consider such components) as the basis for deriving the index by, for example, canceling the sentence.

Furthermore, the component evaluation unit 15 can increase or decrease an evaluation value of, for example, a certain morpheme (component) depending on whether the relevant component is a subject, object, or predicate of a sentence. As a result, the data analysis system can further have the additional advantageous effect capable of enhancing the accuracy of the data analysis.

### (5) Evaluation in Consideration of Correlation (Co-occurrence) Between Components

The data evaluation unit 17 can derive an index for the evaluation data in consideration of the correlation between a first component included in the evaluation data and a second component included in that evaluation data (co-occurrence, for example, frequency at which both of them appear at the same time). For example, when the evaluation data at least partly includes sentences (texts) and a first keyword (first component) “price” appears in the relevant text, the data evaluation unit 17 can derive the above-described index on the basis of the number of appearances of a second keyword (second component) which appears at a second position (for example, a position included within a specified range including a first position where the first keyword appears) in the vicinity of the first position. As a result, the data analysis system can further have the additional advantageous effect capable of enhancing the accuracy of the data analysis.

### (6) Emotion Analysis

When the evaluation data includes the user's evaluation information about a specified event, the data evaluation unit 17 can extract the emotion of the user, who generated the relevant evaluation data, about the specified event, where the emotion is generated on the basis of the evaluation information, from the relevant evaluation data (that is, can evaluate the emotion included in the evaluation data).

For example, when data included in websites which introduce products and services (such as online product sites and restaurant guides) is an analysis object, the data evaluation unit 17 can evaluate the evaluation data (such as data included in other websites) on the basis of a combination (learning data) of components included in comments (reviews) for the relevant products or services (for example, keywords such as “good,” “fun,” “bad,” and “boring”) and evaluations of the relevant products or services (such as 5-level evaluations of “very good,” “good,” “average,” “bad,” and “very bad”). Under this circumstance, the data evaluation unit 17 can increase or decrease the relevant evaluation result depending on, for example, exaggerated expressions (such as “much” and “very”). Accordingly, the data analysis system can further exhibit the additional advantageous effect capable of enhancing the accuracy of the data analysis.

### Examples Where Data Analysis System Processes Data Other Than Document Data

This embodiment has mainly assumed the case where the data analysis system analyzes the document data, and has explained an example based on such assumption; however, the system can analyze data other than the document data (such as voice data, image data, or video data).

For example, when analyzing the voice data, the above-described system may use the relevant voice data themselves as analysis objects or may covert the relevant voice data into document data and use the converted document data as analysis objects. In the former case, the above-described system can analyze the relevant voice data by, for example, dividing the voice data into partial voices with a specified length to form components, and identifying the relevant partial voices by using an arbitrary voice recognition means (such as the hidden Markov model or the Kalman filter). In the latter case, the above-described system can analyze the data by recognizing voices by using the arbitrary voice recognition algorithm (such as the recognition method using the hidden Markov model) and then applying the same procedures to the recognized data as the procedures explained in the embodiment.

Moreover, when analyzing the image data, the above-described system can analyze the image data by, for example, dividing the image data into partial images of a specified size to form components and identifying the relevant partial images by using an arbitrary image recognition means (such as pattern matching, a support vector machine, or a neural network).

Furthermore, when analyzing the video data, the above-described system can analyze the video data by, for example, dividing each of a plurality of frame images included in the video data into partial images of a specified size to form components and identifying the relevant partial images by using an arbitrary image recognition means (such as pattern matching, a support vector machine, or a neural network).

### Examples of Implementation by Software and Hardware

A control block of the data analysis system may be implemented by a logical circuit (hardware) formed on, for example, an integrated circuit (IC chip) or may be implemented by software by using the CPU. In the latter case, the above-described system includes, for example, a CPU for executing a program which is software for implementing each function (a control program of the data analysis program); a ROM (Read Only Memory) or a storage device (collectively referred to as the “storage media”) in which the above-mentioned program and various kinds of data are recorded in a manner such that they can be read by the computer (or CPU); and a RAM (Random Access Memory) for expanding the above-mentioned program. Then, the object of this data analysis system is achieved by the computer (or CPU) reading the above-mentioned program from the above-mentioned storage media and executing it. As the above-mentioned storage media, “tangible media which are not temporary” such as tapes, disks, cards, semiconductor memories, or programmable logical circuits can be used. Furthermore, the above-mentioned program may be supplied to the above-mentioned computer via an arbitrary transmission medium capable of transmitting the relevant program (such as a communication network or a broadcast wave). This data analysis system can also be implemented in a form of a data signal embedded in a carrier wave in which the above-mentioned program is embodied via electronic transmission. It should be noted that the above-mentioned program can be implemented by using, for example, a script language such as Python, ActionScript, or JavaScript (registered trademarks), an object-oriented programming language such as Objective-C or Java (registered trademarks), and a markup language such as HTML5. Furthermore, an arbitrary storage medium in which the above-described program is recorded also falls into the scope of this data analysis system.

### Examples of Other Applications

The above-described system can be implemented as an artificial intelligence system for analyzing big data (an arbitrary system capable of evaluating the relation between the data and a specified case), for example, a discovery support system, a forensic system, an e-mail monitoring system, a medical application system (such as a pharmacovigilance support system, a clinical trial efficiency improvement system, a medical risk hedge system, a fall-prediction [fall-prevention] system, a prognosis prediction system, or a diagnostic support system), an Internet application system (such as a SmartMail system, an information aggregation [curation] system, a user monitoring system, or a social media management system), an information leakage detection system, a project evaluation system, a marketing support system, an intellectual property evaluation system, an unfair trade monitoring system, a call center escalation system, or a credit investigation system. Incidentally, depending on a field to which the data analysis system according to the present invention is applied, for example, preprocessing (for example, for extracting important parts from the relevant data or setting only the important parts as objects of the data analysis) may be executed on the data or the aspect of displaying the data analysis results may be changed in consideration of circumstances specific to such field. Those skilled in the art understand that a variety of such variations exist, and all the variations fall into the scope of the present invention.

The present invention is not limited to each of the aforementioned embodiments and can be changed in various ways within the scope of claims and an embodiment obtained by combining the technical means disclosed respectively in the different embodiments is also included in the technical scope of the present invention. Furthermore, a new technical feature can be formed by combining the technical means disclosed respectively in the respective embodiments.

### INDUSTRIAL APPLICABILITY

The present invention can be applied to a wide variety of arbitrary computers such as personal computers, server apparatuses, workstations, and mainframes.

### REFERENCE SIGNS LIST

1 Data analysis system; 2 server apparatus; 3 client device; 4 database; 5 storage system; 6 management computer; 10 predictive coding unit; 11 data acquisition unit; 12 classification information acquisition unit; 13 data classification unit; 14 component extraction unit; 15 component evaluation unit; 16 component storage unit; 17 data evaluation unit; and 18 management unit.

1.-8. (canceled)

9. A data analysis system for causing artificial intelligence to function by execution of a program by a computer, causing the artificial intelligence to evaluate data while having the artificial intelligence grow through a learning step, and enabling visualization of the growth of the artificial intelligence on the basis of the evaluation, the data analysis system comprising:
a classification setting means that sets a plurality of classifications according to a relation with a specified event, the plurality of classifications including at least a first classification and a second classification different from the first classification wherein the first classification or the second classification is set to each of a plurality of pieces of data;
an index determination means that causes the artificial intelligence to determine an index as a result of the evaluation for each of the plurality of pieces of data at each of specified timings within a period of time from start of the growth of the artificial intelligence to an end of the growth;
a timing setting means that sets first timing and second timing after the first timing from among the specified timings;
a first setting means that sets an index determined at the first timing by the index determination means to each of the plurality of pieces of data to which the first classification is assigned, and to each of the plurality of pieces of data to which the second classification is assigned;
a second setting means that sets an index determined at the second timing by the index determination means to each of the plurality of pieces of data to which the first classification is assigned, and to each of the plurality of pieces of data to which the second classification is assigned;
a display processing means that has a display means display a distribution of the index set by the first setting means and the index set by the second setting means with respect to a reference area that is set to include a range within which the index at the first timing is equal to the index at the second timing; and
an aspect changing means that changes an aspect of displaying the distribution according to a stage of the growth of the artificial intelligence by having the timing setting means change the first timing and the second timing according to the stage of the growth of the artificial intelligence.

10. The data analysis system according to claim 1, wherein the artificial intelligence is made to:
learn a pattern characterizing sample data by calculating a degree that each of a plurality of components contained in the sample data contributes to a combination of the sample data and the classification of the sample data; and
select the plurality of pieces of data as a data group for visualizing a growth process of the artificial intelligence from among the plurality of pieces of evaluation data;
wherein the classification setting means sets the first classification or the second classification to each of the plurality of pieces of selected data; and
wherein the index determination means causes the artificial intelligence to determine the index for each of the plurality of pieces of data on the basis of the learned pattern.

11. The data analysis system according to claim 1, wherein the classification setting means sets classification indicating that the relevant data is related to the specified event, as the first classification and classification indicating that the relation to the specified event is lower than the first classification, as the second classification, respectively, to each of the plurality of pieces of data.

12. The data analysis system according to claim 1,
wherein the timing setting means sets the first timing and the second timing as timings belonging to a stage where the artificial intelligence starts growing; and
wherein the aspect changing means changes the aspect of displaying the distribution so that the index for the data to which the first classification is assigned, and the index for the data to which the second classification is assigned are distributed in a mixed manner along the reference area.

13. The data analysis system according to claim 4, wherein the aspect changing means changes the aspect of displaying the distribution so as to distribute the index for the data to which the first classification is assigned, and the index for the data to which the second classification is assigned so that they are focused in an area of a small value of the evaluation in the reference area.

14. The data analysis system according to claim 4, wherein the timing setting means sets the first timing and the second timing at timings belonging to a stage where the artificial intelligence is growing, so that the aspect changing means changes the aspect of displaying the distribution so as to distribute the index for the data to which the first classification is assigned, and the index for the data to which the second classification is assigned so that the index for the data to which the first classification is assigned, and the index for the data to which the second classification is assigned are separated from each other.

15. The data analysis system according to claim 6, wherein the timing setting means changes the aspect of displaying the distribution so that the index for the data to which the first classification is assigned is distributed to become a higher value at the second timing than at the first timing and the index for the data to which the second classification is assigned is distributed to become a lower value at the second timing than at the first timing, with respect to the reference area.

16. The data analysis system according to claim 1,
wherein the timing setting means sets the first timing and the second timing at timings belonging to a stage where the artificial intelligence is growing; and
wherein the aspect changing means changes the aspect of displaying the distribution so that the index for the data to which the first classification is assigned is distributed to become a higher value at the second timing than at the first timing and the index for the data to which the second classification is assigned is distributed to become a lower value at the second timing than at the first timing, with respect to the reference area.

17. The data analysis system according to claim 6, wherein the timing setting means sets the first timing and the second timing at timings belonging to a stage where the growth of the artificial intelligence has become stable, so that the aspect changing means changes the aspect of displaying the distribution so as to distribute the index for the data to which the first classification is assigned, and the index for the data to which the second classification is assigned so that the index for the data to which the first classification is assigned, and the index for the data to which the second classification is assigned are located along the reference area.

18. The data analysis system according to claim 9, wherein the aspect changing means changes the aspect of displaying the distribution so that the index for the data to which the first classification is assigned is distributed to become a high value at both the first timing and the second timing and the index for the data to which the second classification is assigned is distributed to become a low value at both the first timing and the second timing.

19. The data analysis system according to claim 6,
wherein the timing setting means sets the first timing and the second timing at timings belonging to a stage where the growth of the artificial intelligence has become stable; and
wherein the aspect changing means changes the aspect of displaying the distribution so that the index for the data to which the first classification is assigned is distributed to become a high value at both the first timing and the second timing and the index for the data to which the second classification is assigned is distributed to become a low value at both the first timing and the second timing, along the reference area.

20. A data analysis control method for causing artificial intelligence to function by execution of a program by a controller as a hardware resource of a computer, causing the artificial intelligence to evaluate data while having the artificial intelligence grow through a learning step, and enabling visualization of the growth of the artificial intelligence on the basis of the evaluation,
wherein the controller executes:
a classification setting step of setting a plurality of classifications according to a relation with a specified event, the plurality of classifications including at least a first classification and a second classification different from the first classification wherein the first classification or the second classification is set to each of a plurality of pieces of data;
an index determination step of causing the artificial intelligence to determine an index as a result of the evaluation for each of the plurality of pieces of data at each of specified timings within a period of time from start of the growth of the artificial intelligence to an end of the growth;
a timing setting step of setting first timing and second timing after the first timing from among the specified timings;
a first setting step of setting an index determined at the first timing in the index determination step to each of the plurality of pieces of data to which the first classification is assigned, and to each of the plurality of pieces of data to which the second classification is assigned;
a second setting step of setting an index determined at the second timing in the index determination step to each of the plurality of pieces of data to which the first classification is assigned, and to each of the plurality of pieces of data to which the second classification is assigned;
a display processing step of having a display means display a distribution of the index set in the first setting step and the index set in the second setting step with respect to a reference area that is set to include a range within which the index at the first timing is equal to the index at the second timing; and
an aspect changing step of changing an aspect of displaying the distribution according to a stage of the growth of the artificial intelligence by changing the first timing and the second timing according to the stage of the growth of the artificial intelligence in the timing setting step.

21. A computer-readable storage medium storing a program for causing a computer to function so as to cause artificial intelligence to evaluate data while having the artificial intelligence grow through a learning step, and enabling visualization of the growth of the artificial intelligence on the basis of the evaluation,
wherein the computer is caused to implement:
a classification setting function that sets a plurality of classifications according to a relation with a specified event, the plurality of classifications including at least a first classification and a second classification different from the first classification wherein the first classification or the second classification is set to each of a plurality of pieces of data;
an index determination function that causes the artificial intelligence to determine an index as a result of the evaluation for each of the plurality of pieces of data at each of specified timings within a period of time from start of the growth of the artificial intelligence to an end of the growth;
a timing setting function that sets first timing and second timing after the first timing from among the specified timings;
a first setting function that sets an index determined at the first timing by the index determination function to each of the plurality of pieces of data to which the first classification is assigned, and to each of the plurality of pieces of data to which the second classification is assigned;
a second setting function that sets an index determined at the second timing by the index determination function to each of the plurality of pieces of data to which the first classification is assigned, and to each of the plurality of pieces of data to which the second classification is assigned;
a display processing function that has a display means display a distribution of the index set by the first setting function and the index set by the second setting function with respect to a reference area that is set to include a range within which the index at the first timing is equal to the index at the second timing; and
an aspect changing function that changes an aspect of displaying the distribution according to a stage of the growth of the artificial intelligence by having the timing setting function change the first timing and the second timing according to the stage of the growth of the artificial intelligence.
